(19) United States
(12) Patent Application Publication
(10) Pub. No.: US 2003/0061136 A1
(43) Pub. Date: Mar. 27, 2003

(54) Software license management system

(76) Inventor: Aiichi Inoue, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/212,814

(22) Filed: Aug. 7, 2002

(30) Foreign Application Priority Data
Sep. 26, 2001 (JP) 2001-294557

(51) Int. Cl. G06F 17/60

(52) U.S. Cl. 705/35

(57) ABSTRACT

When receiving a signal to make a request to get permission for the use of a software program to be executed from a computer (102), a license management apparatus (103) gives permission for the use of the software program when the current number of licensed copies of the software program concurrently being used is less than a licensed maximum. After that, the license management apparatus (103) inquires about the status of use of the software program of the computer (102) and updates the current number of licensed copies of the software program concurrently being used according to a response to the inquiry from the computer (102).

### BACKGROUND OF THE INVENTION

1. Field of the Invention

The present invention relates to a software license management system and more particularly to a software license management system that, when a computer desires to execute a software program, can dynamically give the computer permission for the use of the software program.

2. Description of Related Art

Conventionally, methods of dynamically managing software licenses when executing a software program have been provided in order to prevent illegal use of the software program and to limit the number of copies of the software program being executed at the same time. FIG. 21 is a block diagram showing the structure of a prior art software license management system. In the figure, reference numeral 901 denotes a network, reference numeral 902 denotes a computer, and reference numeral 903 denotes a license management apparatus.

In operation, when the computer 902 desires to use a software program, it starts up this software program (“startup” means preparation to execution of the software such as loading) and also inquires of the license management apparatus 903 whether or not the software program which the computer desires to use is available by way of the network 901. The computer then uses the software program after making sure that a signal indicating that the use of the software program is allowed has been returned from the license management apparatus 903. After that, when terminating the use of the software program, the computer 902 transmits a notification indicating the termination of the software program to the license management apparatus 903 by way of the network 901. In contrast, when a signal indicating that the use of the software program is not allowed is returned from the license management apparatus 903, the computer 902 does not use the software program.

On the other hand, when the license management apparatus 903 receives an inquiry about whether or not the software program is available from the computer 902 by way of the network 901, if the current number of copies of the software program concurrently being used at the user site is not equal to or greater than a licensed maximum the license management apparatus 903 transmits a signal indicating that the use of the software program is allowed to the computer 902 by way of the network 901 and increments the current number of copies of the software program concurrently being used by 1. After that, the license management apparatus 903 decrements the number of copies of the software program concurrently being used by 1 when receiving a notification about the termination of the use of the software program from the computer 902. In contrast, when the current number of copies of the software program concurrently being used at the user site is equal to or greater than the licensed maximum, the license management apparatus 903 transmits a signal indicating that the use of the software program is not allowed to the computer 902 by way of the network 901.

Patent application publications associated with technologies in this field have been investigated. Japanese patent application publication (TOKKAIHEI) No. 9-319571 titled “Software license management system” discloses a technology of, to prevent illegal use of the software program by preventing license information used for determining whether to give permission for the use of a software program selected by a user from being falsified, encrypting the license information in advance, reading the license information from a storage unit when receiving a request for license authentication from a client, decrypting the encrypted license information, and determining whether to give permission for the use of the software program according to the contents of a plaintext included in the encrypted license information when it is correctly deciphered.

Japanese patent application publication (TOKKAIHEI) No. 10-228504 titled “Software license management system and software license management apparatus” discloses a technology of using electronic mails for transmission of information between a software execution apparatus on a user's side and a software license management apparatus for managing software licenses, and receiving and processing a request for issue of licenses, verification of licenses, or updating of licenses from the user's side using electronic mails in the software license management apparatus.

A problem with the prior art license management system shown in FIG. 21 is that when the software program used by the computer 902 terminates abnormally for some reason, for example, the notification about the abnormal termination of the software program remains to be transmitted from the computer 902 to the license management apparatus 903 and hence the license management apparatus 903 cannot decrement the current number of copies of the software program concurrently being used by 1, and therefore there is a possibility that any further license to use the software program is not provided for the user site even if the current number of copies of the software program concurrently being used is less than a licensed maximum.

While the technology disclosed by Japanese patent application publication (TOKKAIHEI) No. 9-319571 titled “Software license management system” has a main means of encrypting license information to prevent illegal use of the software program, it does not has any control process of making a request for permission for the use of the software program and then allowing the license management apparatus to inquire about the status of use of the software program of the computer which is licensed to use the software program.

While the technology disclosed by Japanese patent application publication (TOKKAIHEI) No. 10-228504 titled “Software license management system and software license management apparatus” has a main means of using electronic mails for transmission of information between the software execution apparatus and the software license management apparatus to prevent illegal use of the software program, the system does not perform communicates between the computer and the software license management apparatus by using signals and does not contain a control process of allowing the license management apparatus to check the status of use of the software program. The software license management system does not have any embodied algorithm for determining whether to give the computer permission for the use of the software and does not take a result of checking the status of use of the software program into consideration for the next determination of whether to give permission for the use of the software.

### SUMMARY OF THE INVENTION

The present invention is proposed to solve the above-mentioned problems, and it is therefore an object of the present invention to provide a software license management system that can take the fact that a software program, which has been licensed on a computer in response to a preceding request for permission for the use of the software program, has terminated normally or abnormally into consideration so as to determine whether to give permission for the use of the software program in response to a later request for permission for the use of the software program.

It is another object of the present invention to provide a software license management system that when a software program has terminated abnormally, can notify a user or a manager of the computer by an electronic mail of the fact.

It is a further object of the present invention to provide a software license management system that can check to see whether a software program, which has been licensed on a computer in response to a request for permission for the use of the software program, is being normally executed or has terminated abnormally every time a timer interruption is generated at predetermined intervals.

It is still a further object of the present invention to provide a software license management system that can allow another computer, which is different from a computer which is executing a software program which has been licensed on the computer in response to a request for permission for the use of the software program, to check to see whether the software program is being normally executed or has terminated abnormally at an arbitrary time.

In accordance with an aspect of the present invention, there is provided a software license management system including: a software usability checking unit for issuing a request to get permission for the use of a software program, which one information processing unit desires to use, to a license management unit; a software use determination unit, responsive to the request, for determining whether or not a current number N of copies of the software program concurrently being used is less than a licensed maximum, and for sending a response giving permission for the use of the software program and for incrementing N by 1 when N is less than the licensed maximum, whereas sending a response not giving permission for the use of the software program when N is not less than the licensed maximum; and a user number updating unit for, when reported that the information processing unit is executing the software program, waiting for a notification about completion of the software program from the information processing unit, and then decrementing N by 1, and for immediately decrementing N by 1 when reported that the software program has terminated abnormally. As a result, the software license management system can take the status of use of the software program (whether the software program is being executed or has terminated abnormally) into consideration when determining whether to give permission for the use of the software program in response to a later request to get permission for the use of the software program. Thus the possibility that preceding abnormal termination of the software program can deny permission to any further request to get permission for the use of the software program can be eliminated.

In accordance with another aspect of the present invention, there is provided a software license management system including a software usability checking unit for issuing a request to get permission for the use of a software program, which a first information processing unit desires to use, from the first information processing unit to a license management unit; a software use determination unit, responsive to the request, for determining whether or not a current number N of copies of the software program concurrently being used is less than a licensed maximum, and for sending a response giving permission for the use of the software program and for incrementing N by 1 when N is less than the licensed maximum, whereas sending a response not giving the first information processing unit permission for the use of the software program when N is not less than the licensed maximum; a software use status checking unit for inquiring about an execution state of the software program of the first information processing unit after receiving the response from the software use determination unit or when receiving an inquiry signal for inquiring about the execution state of the software program from a second information processing unit; and a user number updating unit for, when reported that the first information processing unit is executing the software program, waiting for a notification about completion of the software program from the first information processing unit, and then decrementing N by 1, and for immediately decrementing N by 1 when reported that the software program has terminated abnormally. As a result, the software license management system can take the status of use of the software program into consideration when determining whether to give permission for the use of the software program in response to a later request to get permission for the use of the software program. Thus the possibility that preceding abnormal termination of the software program can deny permission to any further request to get permission for the use of the software program can be eliminated. In addition, since the software use status checking unit can inquire about the execution state of the software program of the first information processing unit in response to an inquiry signal transmitted thereto at an arbitrary time from the second information processing unit different from the first information processing unit executing the software program, the software license management system can surely count out the number of copies of the software that have terminated abnormally and are not used now from the current number of copies of the software concurrently being used at an arbitrary time.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a software license management system according to a first embodiment of the present invention;

FIG. 2 is a block diagram showing the structure of a computer which executes software and a license management apparatus in the software license management system according to the first embodiment of the present invention;

FIG. 3 is a flow chart showing the operation of the software license management system according to the first embodiment of the present invention;

FIG. 4 is a flow chart showing the operations of sub routines of the software license management system according to the first embodiment of the present invention;

FIG. 5 is a block diagram showing the structure of a variant of the software license management system according to the first embodiment of the present invention;

FIG. 6 is a block diagram showing the structure of a license management apparatus of the software license management system as shown in FIG. 5;

FIG. 7 is a flow chart showing the operation of the software license management system as shown in FIG. 5;

FIG. 8 is a flow chart showing the operations of sub routines of the software license management system as shown in FIG. 5;

FIG. 9 is a block diagram showing the structure of another variant of the software license management system according to the first embodiment of the present invention;

FIG. 10 is a block diagram showing the structure of a license management apparatus of the software license management system as shown in FIG. 9;

FIG. 11 is a flow chart showing the operation of the software license management system as shown in FIG. 9;

FIG. 12 is a flow chart showing the operations of sub routines of the software license management system as shown in FIG. 9;

FIG. 13 is a block diagram showing the structure of a software license management system according to a second embodiment of the present invention;

FIG. 14 is a block diagram showing the structure of a license management apparatus of the software license management system according to the second embodiment of the present invention;

FIG. 15 is a flow chart showing the operation of the software license management system according to the second embodiment of the present invention;

FIG. 16 is a flow chart showing the operations of sub routines of the software license management system according to the second embodiment of the present invention;

FIG. 17 is a block diagram showing the structure of a variant of the software license management system according to the second embodiment of the present invention;

FIG. 18 is a block diagram showing the structure of a license management apparatus of the software license management system as shown in FIG. 17;

FIG. 19 is a flow chart showing the operation of the software license management system as shown in FIG. 17;

FIG. 20 is a flow chart showing the operations of sub routines of the software license management system as shown in FIG. 17; and

FIG. 21 is a block diagram showing the structure of a prior art software license management system.

### DETAILED DESCRIPTION OF THE PREFERRED EMBODIMENTS

The invention will be now described with reference to the accompanying drawings.

### Embodiment 1.

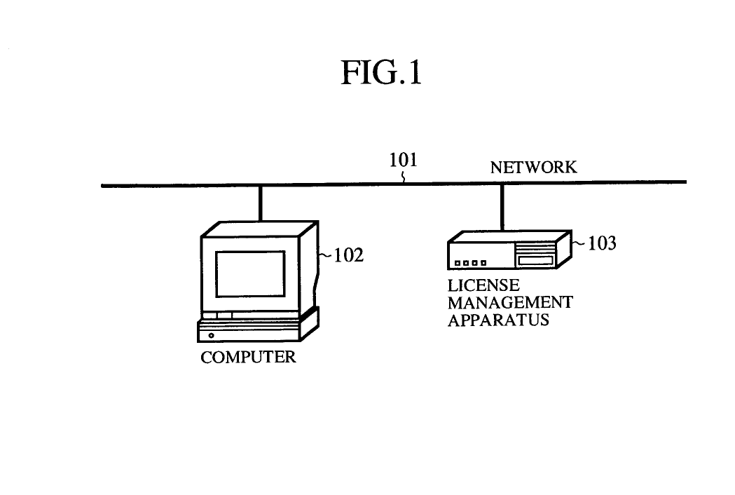

FIG. 1 is a block diagram showing the structure of a software license management system according to a first embodiment of the present invention. In FIG. 1, reference numeral 101 denotes a network, reference numeral 102 denotes a computer (information processing means) that can execute one or more software programs, and reference numeral 103 denotes a license management apparatus (license management means) that can determine whether to give the computer 102 permission for the use of a software program which the computer 102 desires to use. The network 101 can contain the Internet as a route. As an alternative, the whole of the network 101 can be the Internet. Furthermore, a plurality of computers 102 can be provided and a plurality of license management apparatuses 103 can be provided.

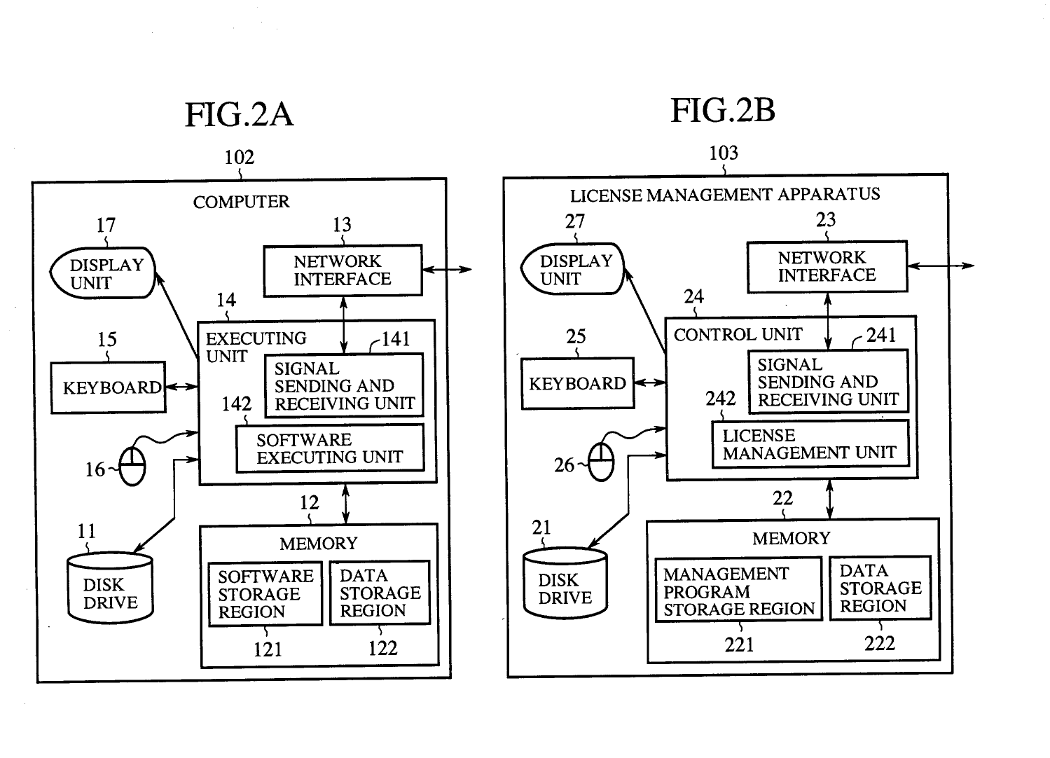

FIGS. 2A and 2B are block diagrams showing the structure of each computer that can execute one or more software programs and the structure of each license management apparatus, in the software license management system according to the first embodiment of the present invention. FIG. 2A shows the structure of each computer 102, and FIG. 2B shows the structure of each license management apparatus 103. In FIG. 2A, reference numeral 11 denotes a disk drive introduced for commercial use, reference numeral 12 denotes a memory for storing one or more software programs (in this case, one or more pieces of software which will be licensed on each computer) and data, reference numeral 13 denotes a network interface having protocols used on the network 101, reference numeral 14 denotes an execution unit that can execute one or more software programs, reference numeral 15 denotes a keyboard used for input of instructions and data, reference numeral 16 denotes a mouse used for input of instructions and data, and reference numeral 17 denotes a display unit used for monitoring.

The memory 12 includes a software storage region 121 for storing one or more software programs before and after each of the one or more software programs is licensed on the corresponding computer and a data storage region 122 for storing data necessary for executing each of the one or more software programs. The execution unit 14 is provided with a software execution unit 142 for starting up each software program to be executed and executing the software program after getting permission for the use of each software program and a signal sending and receiving unit 141 for controlling the sending and receiving of signals to and from the license management apparatus 103 by way of the network interface 13 and the network 101.

In FIG. 2B, reference numeral 21 denotes a disk drive for management, for storing user information and so on, reference numeral 22 denotes a memory for storing a software program used for license management and data used for control, reference numeral 23 denotes a network interface having protocols used on the network 101, reference numeral 24 denotes a control unit for executing the software program used for license management, reference numeral 25 denotes a keyboard used for input of instructions and data, reference numeral 26 denotes a mouse used for input of instructions and data, and reference numeral 27 denotes a display unit used for monitoring.

The memory 22 includes a management program storage region 221 for storing the software program used to manage licenses and a data storage region 222 for storing data necessary for the execution of the software program used for license management. The control unit 24 is provided with a license management unit 242 for starting up and executing the software program used for license management and a signal sending and receiving unit 241 for controlling the sending and receiving of signals to and from each computer 102 by way of the network interface 23 and the network 101.

Next, a description will be made as to the operation of the software license management system according to the first embodiment. A user (not shown in the figure) can make a computer 102 execute an instruction to display a menu used for selecting one of software programs stored in the software storage region 121 of the computer 102 on the display unit 17 of the computer by using the keyboard 15 and mouse 16 of the computer so as to select a software program to be executed from the menu displayed on the display unit 17. The software execution unit 142 starts up the software program selected by the user, and the signal sending and receiving unit 141 prepares a license use request signal to make a request to get permission for the use of the software program, which is needed in order for the computer 102 to execute the software program selected by the user, and transmits this prepared software license use request signal to a corresponding license management apparatus 103 by way of the network interface 13 and the network 101 (software usability checking means).

After that, when the signal sending and receiving unit 141 of the computer 102 receives a response to this software license use request signal from the license management apparatus 103 by way of the network 101 and the network interface 13, the software execution unit 142 checks this received signal and, when the received signal indicates permission for the use of the selected software program, executes the above-mentioned software program selected by the user. In contrast, when the received signal does not indicate permission for the use of the software program selected by the user, the software execution unit 142 does not execute the selected software program. At this time, the software execution unit 142 can display a message indicating that the software program selected by the user cannot be licensed on the computer on the display unit 17.

When the computer 102 receives a software use status checking signal transmitted thereto, by way of the network 101 and the network interface 13, from the license management apparatus 103 through the signal sending and receiving unit 141 while the software program is being executed or after the software program has terminated abnormally, a module (not shown in the figure) used for execution state checking in the software execution unit 142 checks the execution state of the software program in response to this received signal so as to check to see whether the software program is being normally executed or a unusual event has occurred during the execution of the software program, and then transmits this checking result to the license management apparatus 103 by way of the network interface 13 and the network 101. The software execution unit 142 can check to see whether the software program is being normally executed or a unusual event has occurred during the execution of the software program based on information acquired by performing communications between tasks: the module used for execution state checking and another module used for response (not shown in the figure and added to the software program so that it can be executed together with the software program), which is another task.

In other words, when the other module used for response immediately responds to the inquiry from the module used for execution state checking, the software execution unit 142 can determine that the software program, which forms the same task together with the other module used for response, is being normally executed, whereas when the software execution unit 142 does not receive a response within a fixed time period from the other module used for response, the software execution unit 142 can determine that the software program is not being executed (i.e., the software program has terminated abnormally because of occurrence of something unusual).

As an alternative, the module used for execution state checking can check to see whether the software program is being normally executed or an unusual event has occurred during the execution of the software program based on information from OS (operating system) that manages control of the computer 102. In this case, it is not necessary to add any module used for response to the software program to be executed. In addition, it is also possible to form the module used for execution state checking as a task of OS. Only when the software program is being normally executed, the software execution unit 142 can report this checking result to the license management apparatus 103. In contrast, if the software program is not being executed normally, no report on the checking result is transmitted and the license management apparatus 103 is allowed to determine that the software program has terminated abnormally because no report is transmitted from the computer 102 within a fixed time period.

After finishing processing necessary for termination of the execution of the software program when the software program has been normally executed and the execution is completed, the computer 102 prepares a license return signal indicating the completion of the use of the software program by means of the signal sending and receiving unit 141 and then transmits the license return signal to the license management apparatus 103 by way of the network interface 13 and network 101.

When each license management apparatus 103 receives a software license use request signal transmitted thereto, by way of the network 101 and the network interface 23, from a computer 102 through the signal sending and receiving unit 241 thereof, the license management unit 242 thereof checks to see whether or not the current number of licensed copies of a selected software program concurrently being used, i.e., the current number of users concurrently using the selected software program is less than a licensed maximum. When the current number of licensed copies of the software program concurrently being used is not less than the licensed maximum, the signal sending and receiving unit 241 prepares and transmits a disabling signal to the computer 102 by way of the network interface 23 and the network 101 (software use determination means).

In contrast, when the current number of licensed copies of the software program concurrently being used is less than the licensed maximum, the license management unit 242 increments the current number of licensed copies of the software program by 1 and the signal sending and receiving unit 241 prepares and transmits an enabling signal to the computer 102 by way of the network interface 23 and the network 101.

After that, the license management apparatus 103 prepares and transmits a software use status checking signal to check the status of use of the selected software program that has been licensed on the computer 102 to this computer by way of the network interface 23 and the network 101 by means of the signal sending and receiving unit 241 (software use status checking means).

When receiving a response to the above-mentioned software use status checking signal from the computer 102 by way of the network 101 and the network interface 23, the license management apparatus 103 checks the response and, if the response indicates that the software program has terminated normally, waits for the license return signal indicating the completion of the use of the software program transmitted thereto by way of the network 101 and the network interface 23, and then decrements the current number of licensed copies of the software program concurrently being used, i.e., the current number of users concurrently using the software program by 1 in response to the license return signal (use number update means). The license management apparatus 103 then finishes the processing associated with the above-mentioned software license use request signal. In contrast, when the license management apparatus 103 receives a response indicating abnormal termination of the selected software program, it immediately decrements the number of users concurrently using the software program by 1 (use number update means), and then finishes the processing associated with the above-mentioned software license use request signal.

When an agreement that no response indicating abnormal termination is transmitted is made in advance, the license management apparatus 103 stands by within only a predetermined time period after the above-mentioned software use status checking signal has been transmitted and then determines that the software program has terminated abnormally when no response indicating normal termination is received within the predetermined time period.

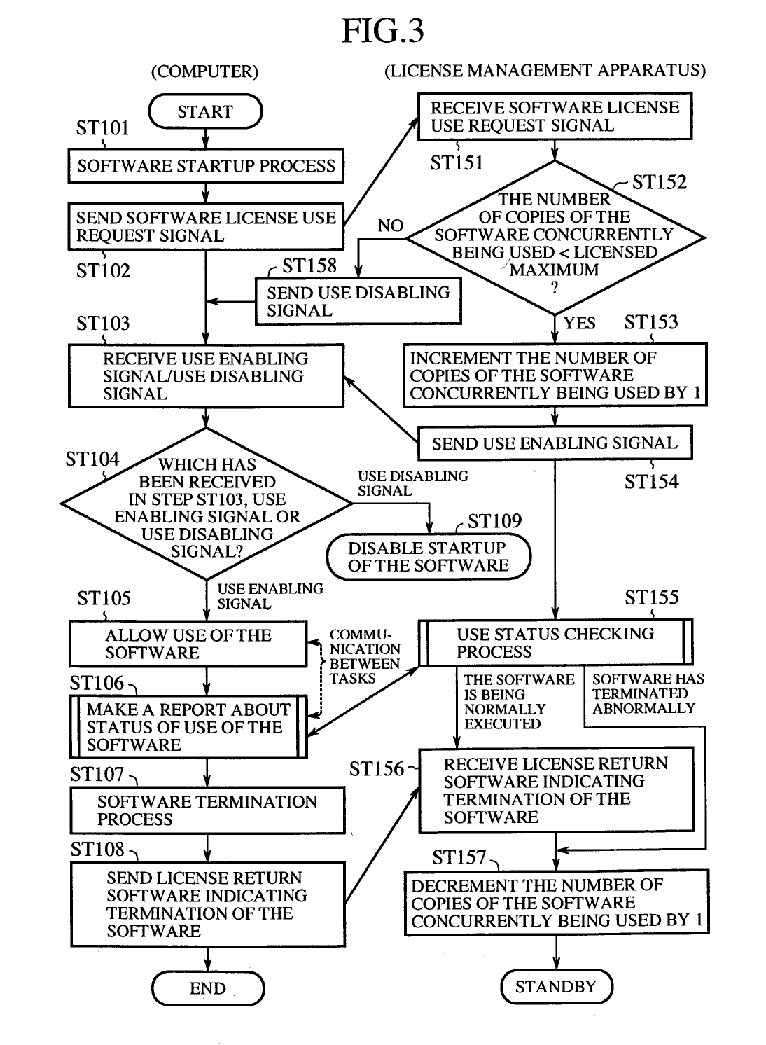

FIG. 3 is a flow chart showing the operation of the software license management system according to the first embodiment of the present invention. Hereafter, the operation of the software license management system according to the first embodiment of the present invention as shown in the flow chart of FIG. 3 will be explained with reference to FIGS. 1, 2A and 2B. Hereafter, assume that a user makes a computer 102 execute an instruction of displaying a menu used for selecting one of software programs stored in the software storage region 121 of the computer on the display unit 17 of the computer by using the keyboard 15 and mouse 16 of the computer so as to select one software program to be executed from among the plurality of software programs included in the menu displayed on the display unit 17.

First of all, the software execution unit 142, in step ST101, starts up a software program selected by the user, in the computer 102. The signal sending and receiving unit 141 then, in step ST102, prepares and transmits a software license use request signal indicating a request for permission for the use of the software program, which is needed in order for the computer 102 to execute the software program, by way of the network interface 13 and the network 101, to a corresponding license management apparatus 103.

On the other hand, when the license management apparatus 103, in step ST151, receives the software license use request signal from the computer 102, the license management apparatus, in step ST152, checks to see whether or not the number of licensed copies of the software program concurrently being used is less than a licensed maximum by means of the license management unit 242. When the current number of licensed copies of the software program concurrently being used is not less than the licensed maximum, the signal sending and receiving unit 241, in step ST158, prepares and transmits a disabling signal to the computer 102 by way of the network interface 23 and the network 101.

In contrast, when the current number of licensed copies of the software program concurrently being used is less than the licensed maximum, the license management unit 242, in step ST153, increments the current number of licensed copies of the software program concurrently being used by 1 and the signal sending and receiving unit 241, in step ST154, prepares and transmits an enabling signal to the computer 102 by way of the network interface 23 and the network 101.

In the computer 102, when the signal sending and receiving unit 141, in step ST103, receives a response to the software license use request signal, by way of the network 101 and the network interface 13, from the license management apparatus 103, the software execution unit 142, in step ST104, checks this received signal. When the received signal indicates the permission for the use of the software program, the software execution unit 142, in step ST105, executes the above-mentioned software program selected by the user. In contrast, when the received signal indicates that the use of the software program is not permitted, the software execution unit 142, in step ST109, does not execute the above-mentioned software program selected by the user. At this time, the software execution unit 142 can display a message showing that the software program selected by the user cannot be licensed on the display unit 17.

On the other hand, the corresponding license management apparatus 103, in step ST155, prepares and transmits a software use status checking signal to check the status of use of the selected software program that has been licensed on the computer 102 to this computer by way of the network interface 23 and the network 101 by means of the signal sending and receiving unit 241.

After that, when receiving a response to the above-mentioned software use status checking signal from the computer 102 by way of the network 101 and the network interface 23, the license management apparatus 103, in step ST155, checks the response and, if the response indicates that the software program has terminated normally, in step ST156, waits for a license return signal indicating the completion of the use of the software program transmitted thereto by way of the network 101 and the network interface 23. Upon receipt of the license return signal, the license management apparatus 103, in step ST157, decrements, the number of licensed copies of the software program concurrently being used by 1 and then finishes the processing associated with the above-mentioned software license use request signal. In contrast, when the license management apparatus 103 receives a response indicating abnormal termination of the software program, it, instep ST157, immediately decrements the number of licensed copies of the software program concurrently being used by 1, and then finishes the processing associated with the above-mentioned software license use request signal.

In the computer 102, when the signal sending and receiving unit 141 receives the software use status checking signal transmitted thereto from the license management apparatus 103 by way of the network 101 and the network interface 13 during the execution of the software program or after the software program has terminated abnormally, the software execution unit 142, in step ST106, checks the execution state of the software program in response to this received signal so as to check to see whether the software program is being normally executed or has terminated abnormally by using a “status report” sub routine, and then transmits this checking result to the license management apparatus 103 by way of the network interface 13 and the network 101.

The computer 102 then, in step ST107, finishes the processing necessary for completing the software program when the software program has been normally executed and the execution is completed, and then, in step ST108, prepares and transmits a license return signal indicating the completion of the use of the software program to the license management apparatus 103 byway of the network interface 13 and the network 101 by means of the signal sending and receiving unit 141.

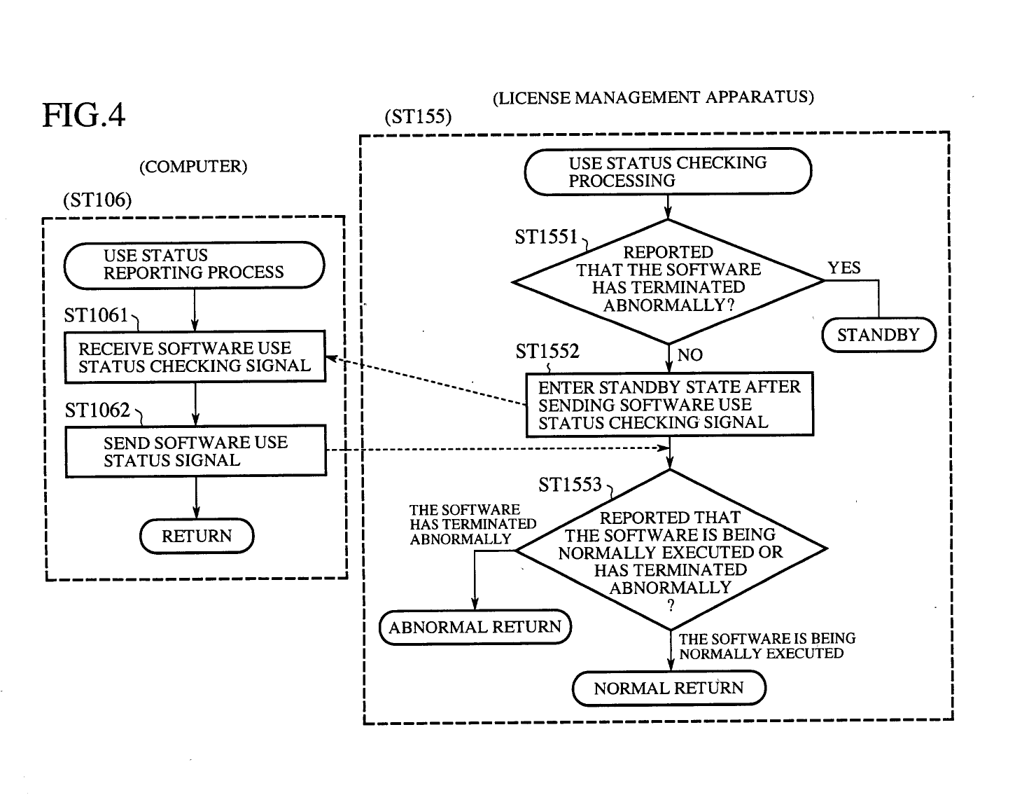

FIG. 4 is a flow chart showing a “use status checking processing” sub routine executed by the software license management system according to the first embodiment of the present invention. The above-mentioned step ST155 is performed by using the “use status checking processing” sub routine shown in FIG. 4. When the “use status checking processing” sub routine is started up, the license management apparatus 103, in step ST1551, checks to see whether it has received a report indicating that the software program specified by the user has already terminated abnormally. If the license management apparatus 103 has already received a report indicating that the software program specified by the user has already terminated abnormally, it enters a standby state in which it is on standby, and otherwise transmits a software use status checking signal to check the status of use of the selected software program to the computer 102 by way of the network interface 23 and the network 101 through the signal sending and receiving unit 241. After that, the license management apparatus 103, in step ST1552, enters a standby state in which it is on standby until it receives a response (report) from the computer 102. When the license management apparatus 103 receives a response from the computer 102, it, in step ST1553, checks the response. The license management apparatus 103 then makes an abnormal return when the report says abnormal termination of the software program, whereas the license management apparatus 103 makes a normal return when the report says that the software program is being executed.

The above-mentioned step ST106 is performed by using a “use status report” sub routine shown in FIG. 4. In the “use status report” sub routine, the software execution unit 142, in step ST1061, starts up the module used for execution state checking at once in response to the software use status checking signal received by the signal sending and receiving unit 141 to make the module used for execution state checking inquire about the execution state of the software program of another module used for response (added to the software program so that it can be executed together with the software program) by using communications between tasks so as to check the execution state of the software program according to a response to the inquiry from the response module used for response.

In other words, the software execution unit 142 determines that the software program is being executed if the signal sending and receiving unit 141 receives a response from the module used for response within a predetermined time period, and otherwise determines that the software program has terminated abnormally. The signal sending and receiving unit 141 then, in step ST1062, transmits this determination result as a report, by way of the network interface 13 and the network 101, to the license management apparatus 103.

In accordance with this embodiment, users are allowed to make any computer 102 on the network execute an instruction to display a menu used for selecting one of software programs stored in the software storage region 121 of the computer on the display unit 17 of the computer by using the keyboard 15 and mouse 16 of the computer and to select a software program to be executed by the computer from the menu displayed on the display unit 17, as previously explained. As an alternative, in each computer a program used for business management (job management function) can be allowed to select a software program to be executed by each computer.

FIG. 5 is a block diagram showing the structure of a variant of the software license management system according to the first embodiment of the present invention. In FIG. 5, reference numeral 201 denotes a network, reference numeral 202 denotes a computer (information processing means) that can execute one or more software programs, reference numeral 203 denotes a license management apparatus (license management means) that can determine whether to give permission for the use of each of the one or more software programs, and reference numeral 204 denotes an information transmission apparatus (electronic mail transmission means) for transmitting electronic mails. The network 201 can contain the Internet as a route. As an alternative, the whole of the network 201 can be the Internet. Furthermore, a plurality of computers 202 can be provided, a plurality of license management apparatuses 203 can be provided, and a plurality of information transmission apparatuses 204 can be provided.

Each computer 202 of the software license management system shown in FIG. 5 includes a component which implements the electronic mail functionality in addition to the structure of the computer 102 as shown in FIG. 2A (the structure of the computer 202 is not shown in the figure).

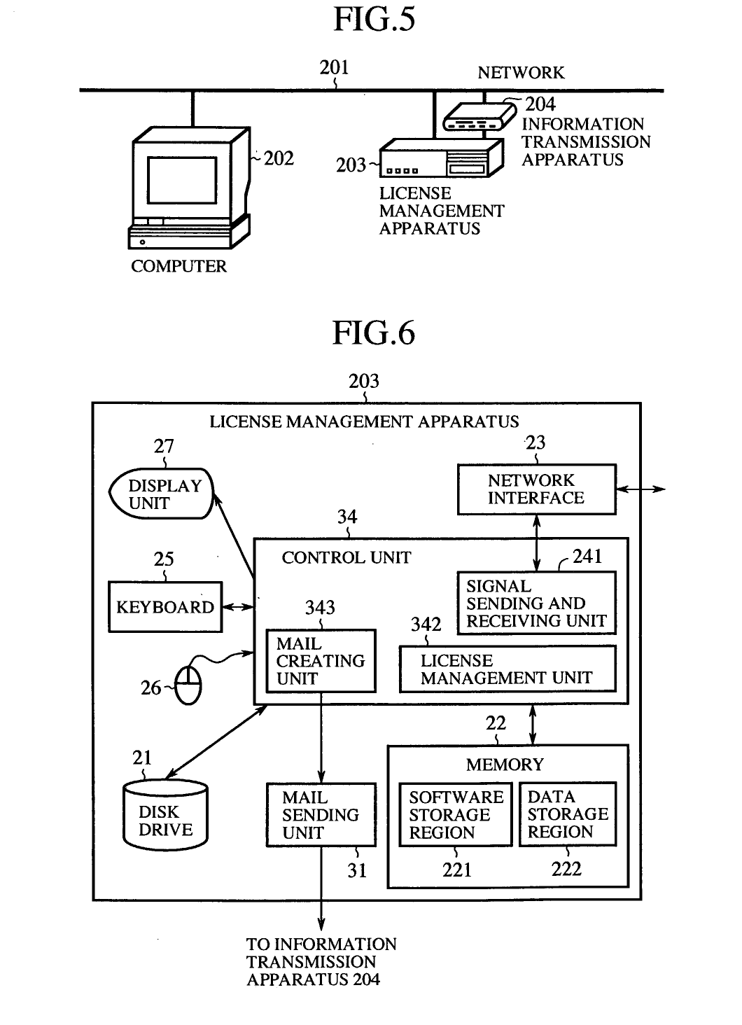

FIG. 6 is a block diagram showing the structure of each license management apparatus of the software license management system as shown in FIG. 5. Each license management apparatus 203 of the software license management system according to this embodiment has the same structure as each license management apparatus 103 shown in FIG. 2B with the exception that it additionally includes an electronic mail sending unit 31 and an electronic mail creating unit 343, which is added to a control unit 34. A license management unit 342 has a function of starting up the electronic mail creating unit 343 when receiving a report about abnormal termination of the software program.

Hereafter, a description will be made as to the operation of each license management apparatus 203, centering on the operation of the electronic mail creating unit 343 of the control unit 34. After the control unit 34 of a corresponding license management apparatus 203 responds to a signal indicating a request for permission for the use of a software program selected on a computer 202 from this computer 202 so as to give permission for the use of the selected software program, the signal sending and receiving unit 241 prepares and transmits a software use status checking signal to check the status of use of the selected software program which has been licensed on the computer 202 to this computer by way of the network interface 23 and the network 201 (software use status checking means).

After that, when a response to the software use status checking signal indicates abnormal termination of the selected software program, the electronic mail creating unit 343 immediately creates a mail text notifying of abnormal termination of the software program and sends the electronic mail text to the information transmission apparatus 204 by way of the electronic mail sending unit 31. The license management unit 342 then decrements the number of licensed copies of the software program concurrently being used by 1 (use number update means), and finishes the process of responding to the software license use request signal.

On the other hand, the information transmission apparatus 204 transmits the electronic mail text transmitted thereto from the electronic mail sending unit 31 to the computer 202 by way of the network 201 and to mobile terminal equipment (mobile terminal means) or a mobile telephone (mobile terminal means) owned by either a software management person who has been registered in advance on the computer 202 or the user who has selected the software program. As an alternative, the information transmission apparatus 204 can transmit the electronic mail text transmitted thereto from the electronic mail sending unit 31 only to mobile terminal equipment or a mobile telephone owned by either a software management person or the user who has selected the software program.

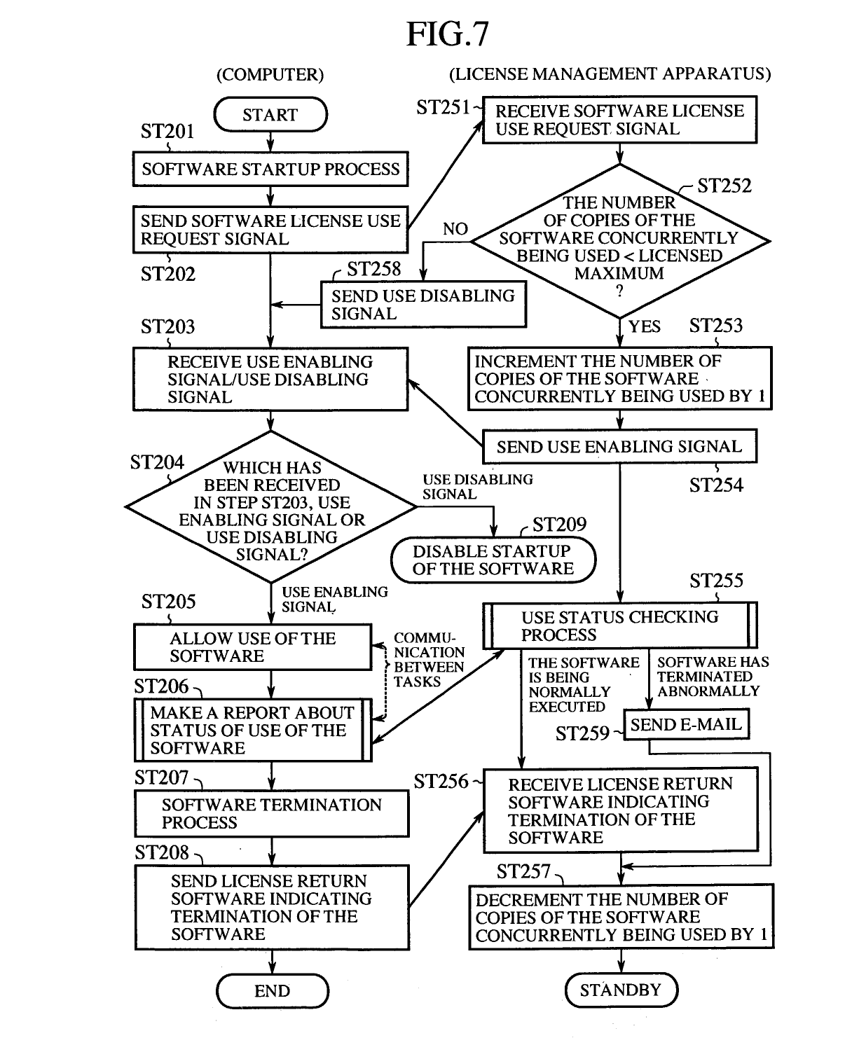

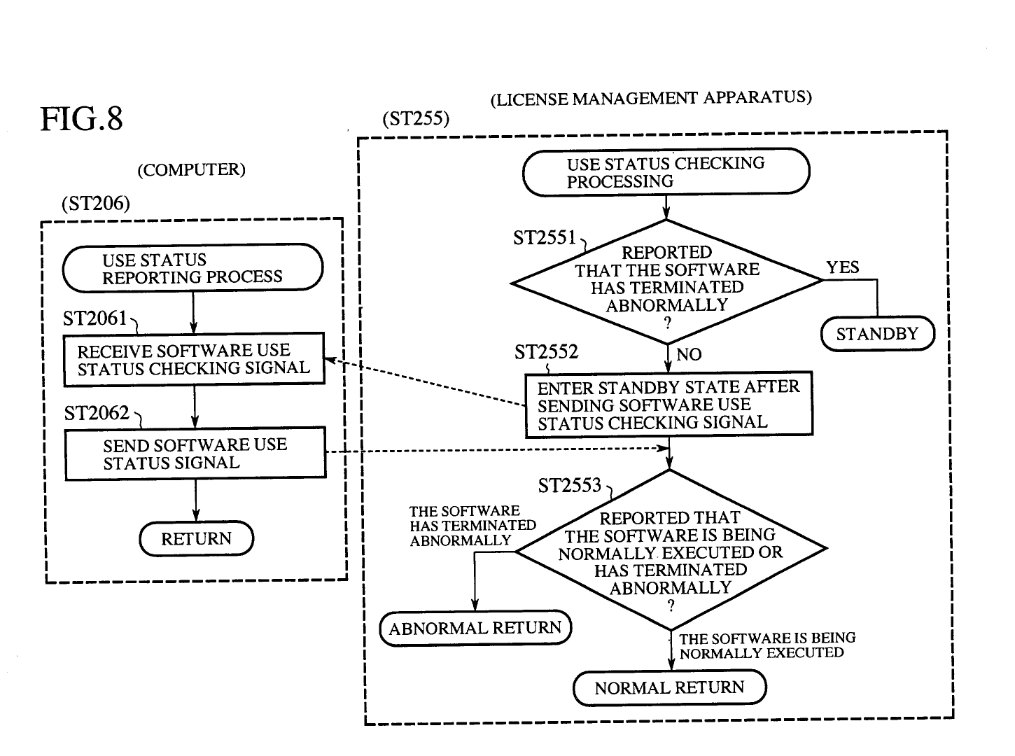

FIG. 7 is a flow chart showing the operation of the software license management system shown in FIG. 5, and FIG. 8 is a flow chart of the operations of sub routines of the software license management system as shown in FIG. 5. In FIG. 7 showing the operation of the software license management system, steps ST201 to ST209 correspond to steps ST101 to ST109 shown in FIG. 3, respectively, and steps ST251 to ST258 correspond to steps ST151 to ST158 shown in FIG. 3, respectively. Furthermore, in FIG. 8 showing the operations of the sub routines of the software license management system, steps ST2061 and ST2062 correspond to steps ST1061 and ST1062 shown in FIG. 4, respectively, and steps ST2551 to ST2553 correspond to steps ST1551 to ST1553 shown in FIG. 4, respectively.

Hereafter, processing performed in step ST259, which is an additional step, will be explained. When the control unit 34 shown in FIG. 6, in step ST255, checks the status of use of the selected software program using a “use status checking processing” sub routine and the checking result indicates abnormal termination, the control unit 34 immediately creates a mail text notifying either a software management person on the computer 202 or the user who has selected the software program on the computer 202 of abnormal termination of the software program through the electronic mail creating unit 343 before performing processing in step ST257 corresponding to step ST157, and sends the electronic mail text to the information transmission apparatus 204 through the electronic mail sending unit 31, in step ST259.

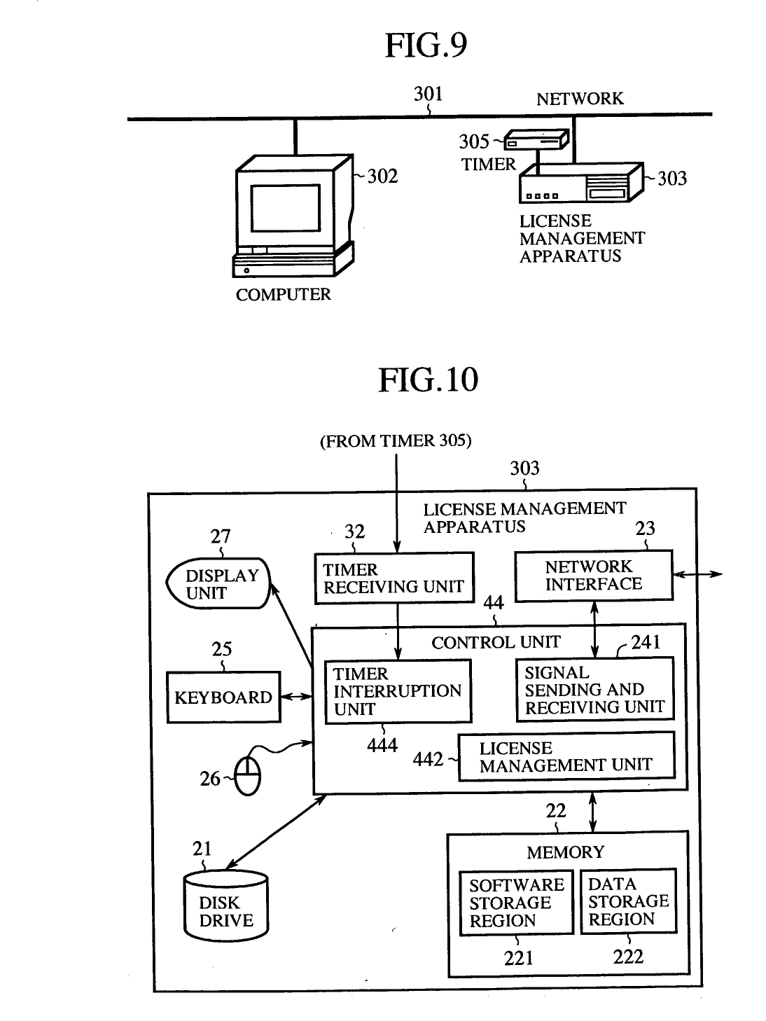

FIG. 9 is a block diagram showing the structure of another variant of the software license management system according to the first embodiment of the present invention. In FIG. 9, reference numeral 301 denotes a network, reference numeral 302 denotes a computer (information processing means) that can execute one or more software programs, reference numeral 303 denotes a license management apparatus (license management means) that can determine whether to give permission for the use of each of the one or more software programs, and reference numeral 305 denotes a timer (timer means) that generates an interruption signal at fixed intervals to check the status of use of each licensed software program. The network 301 can contain the Internet as a route. As an alternative, the whole of the network 301 can be the Internet. Furthermore, a plurality of computers 302 can be provided, a plurality of license management apparatuses 303 can be provided, and a plurality of timers 305 can be provided. Each computer 302 of the software license management system as shown in FIG. 9 has the same structure as each computer 102 of the software license management system as shown in FIG. 2A (the structure of each computer 302 is not shown in the figure).

FIG. 10 is a block diagram showing the structure of each license management apparatus of the software license management system as shown in FIG. 9. Each license management apparatus 303 shown in FIG. 10 has the same structure as each license management apparatus 103 shown in FIG. 2B with the exception that it additionally includes a timer receiving unit 32 and a timer interruption unit 444, which is added to a control unit 44. A license management unit 442 has a function of receiving a timer interruption received by the timer receiving unit 32 by way of the timer interruption unit 444.

Hereafter, the operation of each license management apparatus 303 will be explained, centering on the operation of the timer interruption unit 444 of the control unit 44. The timer 305 generates an interruption to the timer receiving unit 32 of each license management apparatus 303 at fixed intervals. The periodicity of the interruption can be adjusted according to the load conditions of the network 301, each computer 302, and each license management apparatus 303. When each license management apparatus 303 receives the interruption signal to check the status of use of each licensed software program, which is periodically applied thereto from the corresponding timer 305, through the timer receiving unit 32 thereof, it causes the timer receiving unit 32 thereof to immediately generate a timer interruption to the timer interruption unit 444 thereof. The timer interruption causes the license management unit 442 to start a process (software use status checking means) of checking the status of use of each licensed software program.

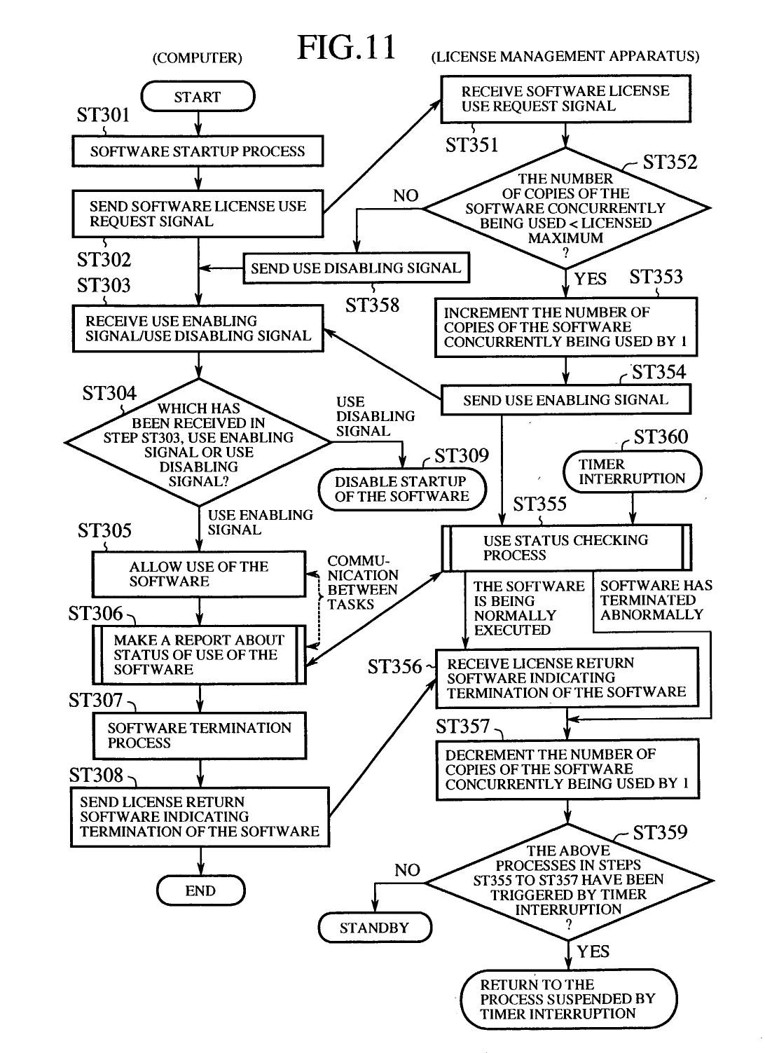

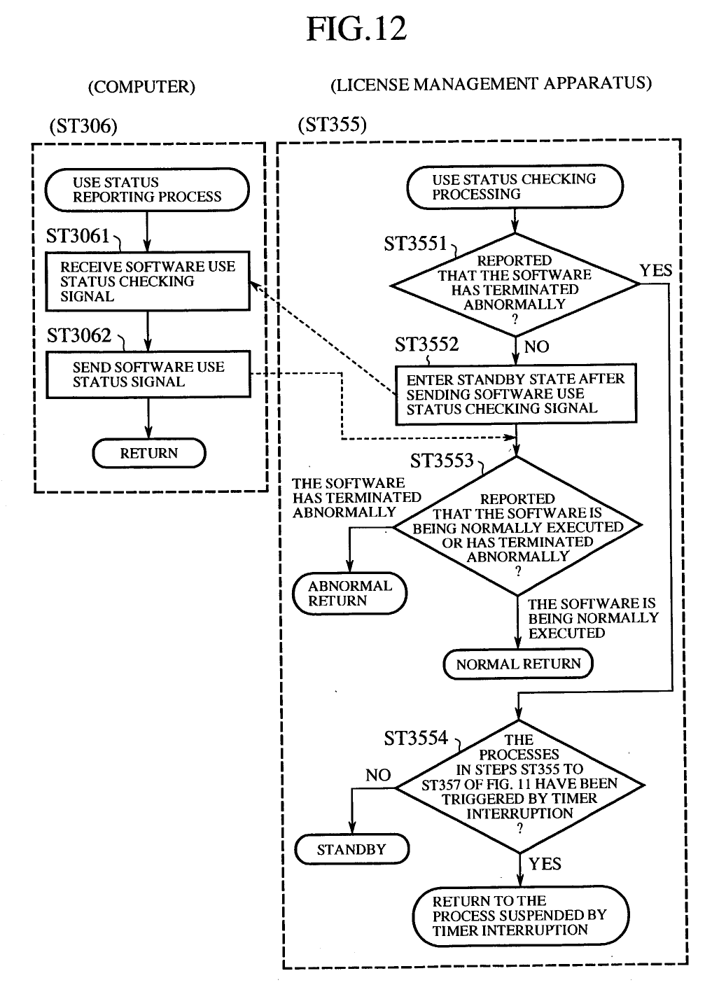

FIG. 11 is a flow chart showing the operation of the software license management system as shown in FIG. 9, and FIG. 12 is a flow chart showing the operations of sub routines of the software license management system as shown in FIG. 9. In FIG. 11 showing the operation of the software license management system, steps ST301 to ST309 correspond to steps ST101 to ST109 shown in FIG. 3, respectively, and steps ST351 to ST358 correspond to steps ST151 to ST158 shown in FIG. 3, respectively. Furthermore, in FIG. 12 showing the operations of the sub routines of the software license management system, steps ST3061 and ST3062 correspond to steps ST1061 and ST1062 shown in FIG. 4, respectively, and steps ST3551 to ST3553 correspond to steps ST1551 to ST1553 shown in FIG. 4, respectively.

Hereafter, processing performed in steps ST359, ST360 (see FIG. 11) and ST3554 (see FIG. 12) which are additional steps will be explained. The license management apparatus 303 shown in FIG. 10 checks to see whether or not the sequence of processes up to step ST357 has been performed, being triggered by the reception of the timer interruption through the timer receiving unit 32 after finishing the sequence of processes up to step ST357, and, if so, returns the flow of control to the instruction address so as to enable the processing performed by the license management apparatus 303 immediately before the timer interruption was generated to be performed in turn. In contrast, when the sequence of processes up to step ST357 has not been performed, being triggered by the reception of the timer interruption (that is, the sequence of processes has been performed, being triggered by the reception of the software license use request signal from the computer 302), the license management apparatus 303 only enters a standby state in step ST359.

When the timer receiving unit 32 receives the interruption signal periodically applied thereto from the timer 305 to check the status of use of the software program, the control unit 44 immediately, in step ST360, generates a timer interruption to the timer interruption unit 444 so as to move the flow of control to step ST355 of using the “use status checking processing” sub routine of the license management unit 442.

As shown in the “use status checking processing” sub routine of FIG. 12, the license management unit 442, in step ST3551, determines whether or not it has been reported that the specified software program has already terminated abnormally, and then, in step ST3554, checks to see whether or not the sequence of processes up to step ST3551 has been performed, being triggered by the reception of the timer interruption through the timer receiving unit 32 when it determines that it has been reported that the specified software program has already terminated abnormally. When the sequence of processes up to step ST3551 has been performed, being triggered by the reception of the timer interruption, the license management unit 442 returns the flow of control to the instruction address so as to enable the processing performed by the license management apparatus 303 immediately before the timer interruption was generated to be performed in turn. In contrast, in step ST3554, when determining that the sequence of processes up to step ST3551 has not been performed, being triggered by the reception of the timer interruption (that is, the sequence of processes has been performed, being triggered by the reception of the software license use request signal from the computer 302), the license management apparatus 303 only enters a standby state.

As mentioned above, in accordance with the first embodiment, each computer 102 (202 or 302) can obtain permission for the use of a selected software program by transmitting a signal (software license use request signal) to make a request for permission for the use of the selected software program to be executed to a corresponding license management apparatus 103 (203 or 303).

After transmitting a use enabling signal in response to a software license use request signal from the computer 102 (202 or 302), the corresponding license management apparatus 103 (203 or 303) checks the execution state of the selected software program which may be being executed with the permission for the use of the software program, and can take the contents of a response (a report indicating whether the software program is being executed or has terminated abnormally) into consideration when determining whether to give permission for the use of the software program in response to a later request for permission for the use of the software program.

When informed of abnormal termination of a selected software program on a computer 202, a corresponding license management apparatus 203 produces and transmits an electronic mail text of notification about the abnormal termination of the software program to the computer 202 and mobile terminal equipment (mobile terminal means) or a mobile telephone (mobile terminal means) owned by either a software management person on the computer 202 or the user who has selected the software program on the computer 202 by way of the information transmission apparatus 204, so that the software management person or user on the computer 202 can be informed of the occurrence of abnormality in the software program and can take measures against the abnormality at an earlier time.

In addition, because each license management apparatus 303 can check the status of use of each software program licensed on a corresponding computer in response to an interruption signal periodically transmitted thereto from the corresponding timer 305, each license management apparatus can surely count out the number of copies of the software program that have terminated abnormally and are not used now from the current number of copies of the software program concurrently being used. As a result, since the possibility that frequent occurrence of abnormal termination of a selected software program can deny permission to any further request for permission for the use of the software program can be eliminated at nighttime or the like during which abnormal termination of the software program can often occur, every computer 302 in the network 301 can perform an unattended continuous operation.

Furthermore, since the periodicity of the generation of interruptions by the timer 305 can be adjusted while the loaded conditions of the network 301, each computer 302, and each license management apparatus 303 are monitored, each license management apparatus can surely count out the number of copies of the software program that have terminated abnormally and are not used now from the current number of licensed copies of the software program concurrently being used.

### Embodiment 2.

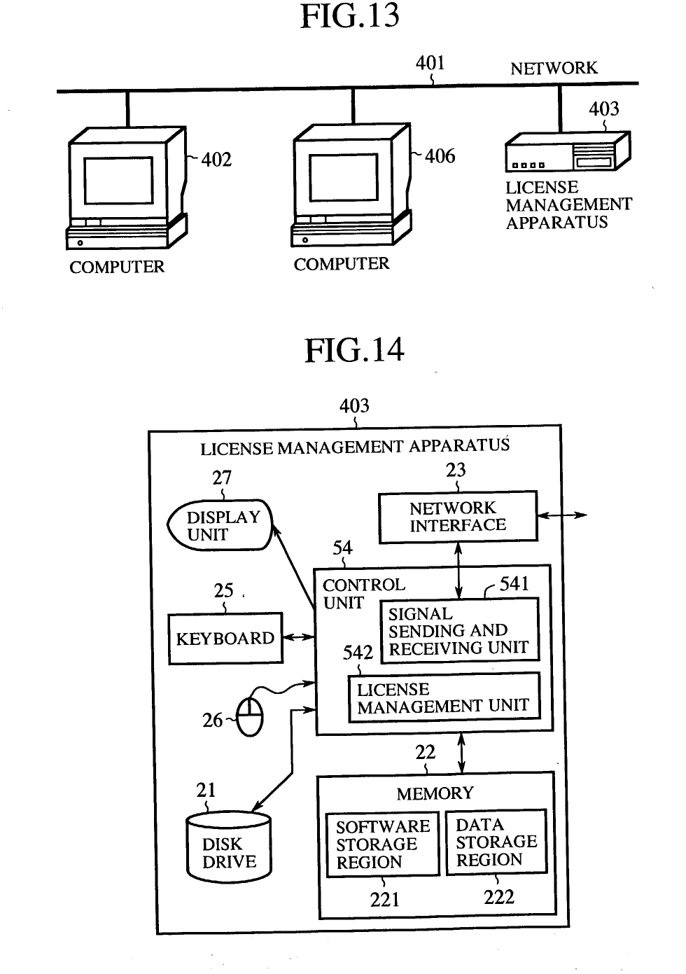

FIG. 13 is a block diagram showing the structure of a software license management system according to a second embodiment of the present invention. In FIG. 13, reference numeral 401 denotes a network, reference numeral 402 denotes a computer (first information processing means) that can execute one or more software programs, reference numeral 403 denotes a license management apparatus (license management means) that can determine whether to give permission for the use of each of the one or more software programs, and reference numeral 406 denotes another computer (second information processing means) that can transmit a software use status checking signal to check the status of use of each licensed software program.

By the way, this computer 406 is the one used for commercial use and for management of the system. When the number of copies of the software program which have terminated abnormally has increased and there causes a situation in which all requests for permission for the use of the software program are rejected, it will take much time for the method of checking the status of use of the software program at fixed intervals only in response to timer interruptions to receive the next interruption. To avoid such an abnormal condition, the computer 406 can transmit a software use status checking signal to always check the status of use of the software program.

The network 401 can contain the internet as a route. As an alternative, the whole of the network 401 can be the internet. Furthermore, a plurality of computers 402 can be provided, a plurality of computers 406 can be provided, and a plurality of license management apparatuses 403 can be provided.

Each computer 402 of the software license management system according to this embodiment has the same structure as each computer 102 of the software license management system according to the first embodiment, and the structure of each computer 402 is not shown in the figure. Each computer 406 of the software license management system according to this embodiment has a component which implements a function of transmitting a software use status checking signal, in addition to the structure of each computer 102 of the software license management system of the first embodiment, and the structure of each computer 406 is not shown in the figure.

FIG. 14 is a block diagram showing the structure of each license management apparatus of the software license management system according to the second embodiment of the present invention. Each license management apparatus 403 of the software license management system according to this embodiment has the same structure as each license management apparatus 103 of the software license management system according to the first embodiment, with the exception that a signal sending and receiving unit 541 has a function of accepting the software use status checking signal from the computer 406, and a license management unit 542 has a function of inquiring about the status of use of each software program licensed on each computer 402 of each computer 402 when the signal sending and receiving unit 541 accepts the software use status checking signal from a corresponding computer 406.

Hereafter, the operation of each license management apparatus 403 will be explained, centering on the functions added to the signal sending and receiving unit 541 and the license management unit 542. The signal sending and receiving unit 541 of a control unit 54 has a function of receiving a software license use request signal from any computer 402 which is managed by each license management apparatus 403 by way of the network 401 and a network interface 23, as well as a function of receiving the software use status checking signal from a corresponding computer 406 by way of the network 401 and the network interface 23.

The license management unit 542 of the control unit 54 has a function (software use determination means) of determining whether to give permission for the use of a software program selected on a computer 402 when the signal sending and receiving unit 541 receives the software license use request signal from the computer 402, as well as a function (software use status checking means) of inquiring about the status of use of each licensed software program of the computer 402 when the signal sending and receiving unit 541 receives the software use status checking signal from the corresponding computer 406.

In this embodiment, while every computer 402 can execute a software program after making a request to get permission for the use of the software program, every computer 406 can also execute a software program after making a request to get permission for the use of the software program, like every computer 402.

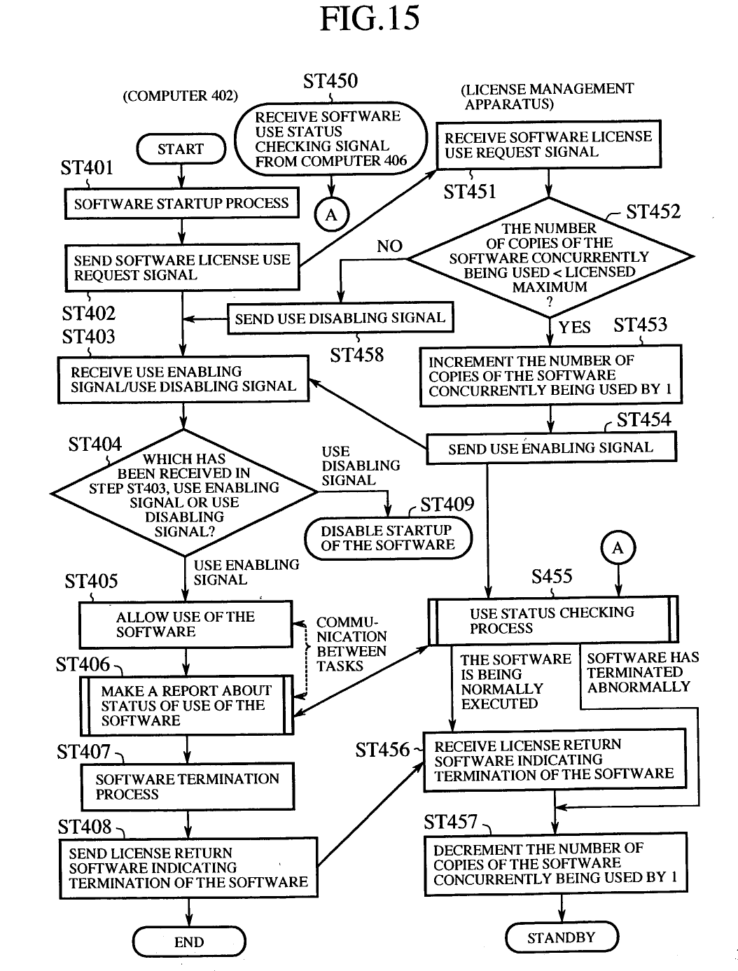

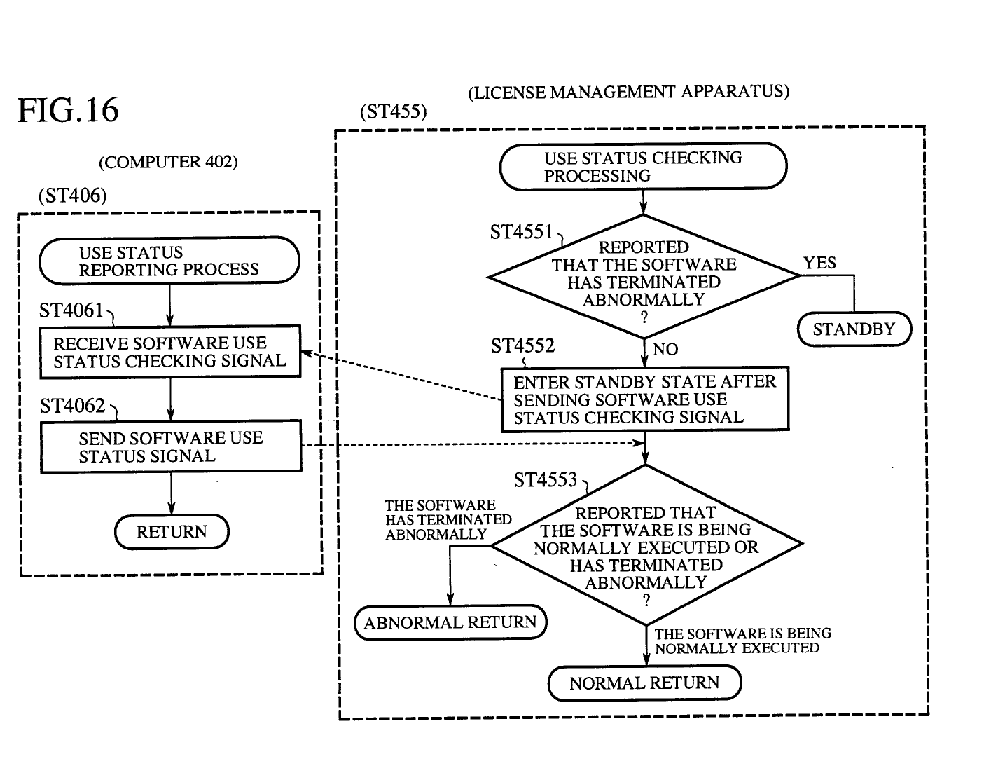

FIG. 15 is a flow chart showing the operation of the software license management system according to the second embodiment of the present invention, and FIG. 16 is a flow chart showing the operations of sub routines of the software license management system according to the second embodiment of the present invention. In FIG. 15 showing the operation of the software license management system according to the second embodiment of the present invention, steps ST401 to ST409 correspond to steps ST101 to ST109 shown in FIG. 3, respectively, and steps ST451 to ST458 correspond to steps ST151 to ST158 shown in FIG. 3, respectively. Furthermore, in FIG. 16 showing the operations of the sub routines of the software license management system according to the second embodiment of the present invention, steps ST4061 and ST4062 correspond to steps ST1061 and ST1062 shown in FIG. 4, respectively, and steps ST4551 to ST4553 correspond to steps ST1551 to ST1553 shown in FIG. 4, respectively.

Hereafter, processing performed in step ST450 which is an additional step will be explained. When the signal sending and receiving unit 541 shown in FIG. 14 receives the software use status checking signal from the corresponding computer 406, the control unit 54 immediately, in step ST450, moves the flow of control to step ST455 of using a “use status checking processing” sub routine of the license management unit 542.

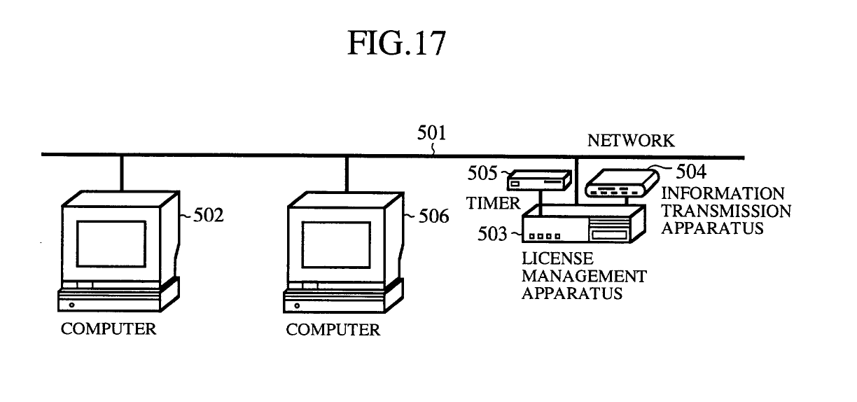

FIG. 17 is a block diagram showing the structure of a variant of the software license management system according to the second embodiment of the present invention. In FIG. 17, reference numeral 501 denotes a network, reference numeral 502 denotes a computer (first information processing means) that can execute one or more software programs, reference numeral 503 denotes a license management apparatus (license management means) that can determine whether to give permission for the use of each of the one or more software programs, reference numeral 504 denotes an information transmission apparatus (electronic mail transmission means) for transmitting an electronic mail, reference numeral 505 denotes a timer (timer means) that can generate an interruption signal at fixed intervals to check the status of use of each software program that is licensed on each computer 502, and reference numeral 506 denotes another computer (second information processing means) that can transmit a software use status checking signal to check the status of use of each software program that is licensed on each computer 502.

The network 501 can contain the Internet as a route. As an alternative, the whole of the network 501 can be the Internet. Furthermore, a plurality of computers 502 can be provided, a plurality of computers 506 can be provided, a plurality of license management apparatuses 503 can be provided, a plurality of information transmission apparatuses 504 can be provided, and a plurality of timers 505 can be provided. Optionally, either the information transmission apparatus 504 or the timer 505 can be omitted.

Each computer 502 of the software license management system according to this variant of the second embodiment includes a component which implements an electronic mail function in addition to the structure of each computer 102 of the software license management system according to the first embodiment (the structure of each computer 502 is not shown in the figure). Each computer 506 of the software license management system according to this variant of the second embodiment includes a component which implements a function of transmitting a software use status checking signal in addition to the structure of each computer 102 of the software license management system according to the first embodiment (the structure of each computer 506 is not shown in the figure).

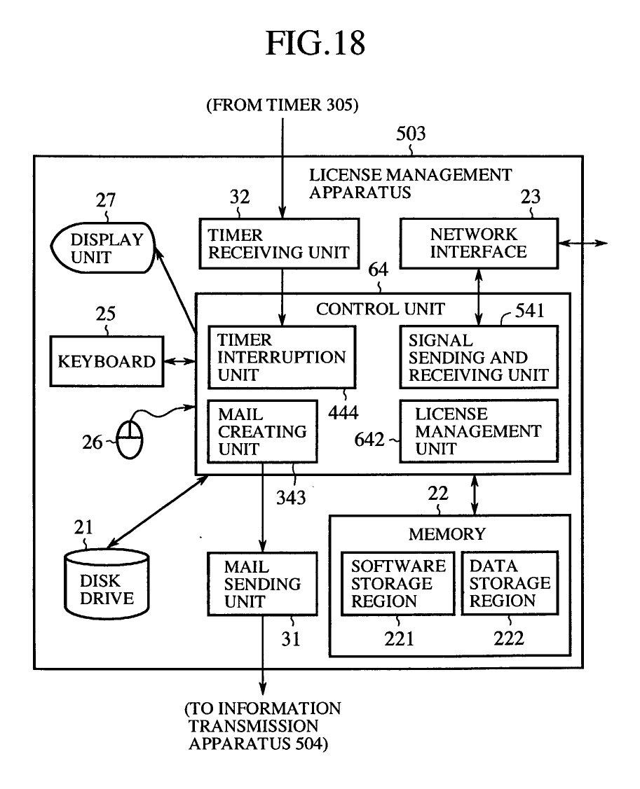

FIG. 18 is a block diagram showing the structure of each license management apparatus of the software license management system as shown in FIG. 17. Each license management apparatus 503 shown in FIG. 18 has the same structure as each license management apparatus 103 shown in FIG. 2B with the exception that it includes an electronic mail sending unit 31, a timer receiving unit 32, and a mail creating unit 343 and a timer interruption unit 444, which are added to a control unit 64. A signal sending and receiving unit 541 has a function of accepting the software use status checking signal from each computer 506, and the license management unit 642 has a function of inquiring about the status of use of each software program licensed on each computer 502 of each computer 502. The license management unit 642 has a function of starting up the electronic mail creating unit 343 when receiving a report indicating abnormal termination of a software program and a function of accepting an interruption from the timer receiving unit 32.

Hereafter, the operation of each license management apparatus 503 will be explained, centering on the functions of the electronic mail sending unit 31 and the timer receiving unit 32, and the functions added to the signal sending and receiving unit 541 and the license management unit 642. The signal sending and receiving unit 541 of the control unit 64 has a function of receiving a software license use request signal from each computer 502 by way of the network 501 and a network interface 23, as well as a function of receiving the software use status checking signal from each computer 506 by way of the network 501 and the network interface 23. After responding to the software license use request signal from each computer 502 so as to give permission for the use of a software program selected on each computer 502, the control unit 64 of the license management apparatus 503 prepares and transmits a software use status checking signal associated with each software program which has been licensed on each computer 502 to each computer 502 by way of the network interface 23 and the network 501 through the signal sending and receiving unit 541 so as to check the status of use of each licensed software program (software use status checking means).

After that, when the response to this software use status checking signal indicates abnormal termination of the software program, the electronic mail creating unit 343 immediately creates a mail text notifying the abnormal termination of the software program and sends this mail text to the corresponding information transmission apparatus 504 by way of the electronic mail sending unit 31. Then, the control unit 64 immediately decrements the number of copies of the software program concurrently being used (use number update means), and finishes the process of responding to the software license use request signal.

On the other hand, the corresponding information transmission apparatus 504 transmits the electronic mail text sent from the electronic mail sending unit 31, by way of the network 501, to the computer 502 on which the software program has been licensed and to mobile terminal equipment (mobile terminal means) or a mobile telephone (mobile terminal means) owned by either a software management person who has been registered in advance on the computer 502 or the user who has selected the software program on the computer 502.

The control unit 64 of the license management apparatus 503 receives an interruption signal to check the status of use of the software program, which is periodically transmitted thereto from the timer 505, through the timer receiving unit 32, and immediately generates a timer interruption to the timer interruption unit 444. The timer interruption causes the license management unit 642 to start the process of checking the status of use of the software program.

In addition, the license management unit 642 of the control unit 64 has a function (software use determination means) of, when the signal sending and receiving unit 541 receives a software license use request signal indicating a request to get permission for the use of a software program from a computer 502, determining whether to give permission for the use of the software program, and a function (software use status checking means) of inquiring about the status of use of the software program of the computer 502 when the signal sending and receiving unit 541 receives a software use status checking signal from the corresponding computer 506.

In this embodiment, while every computer 502 can execute a software program after making a request to get permission for the use of the software program, every computer 506 can also execute a software program after making a request to get permission for the use of the software program, like every computer 502.

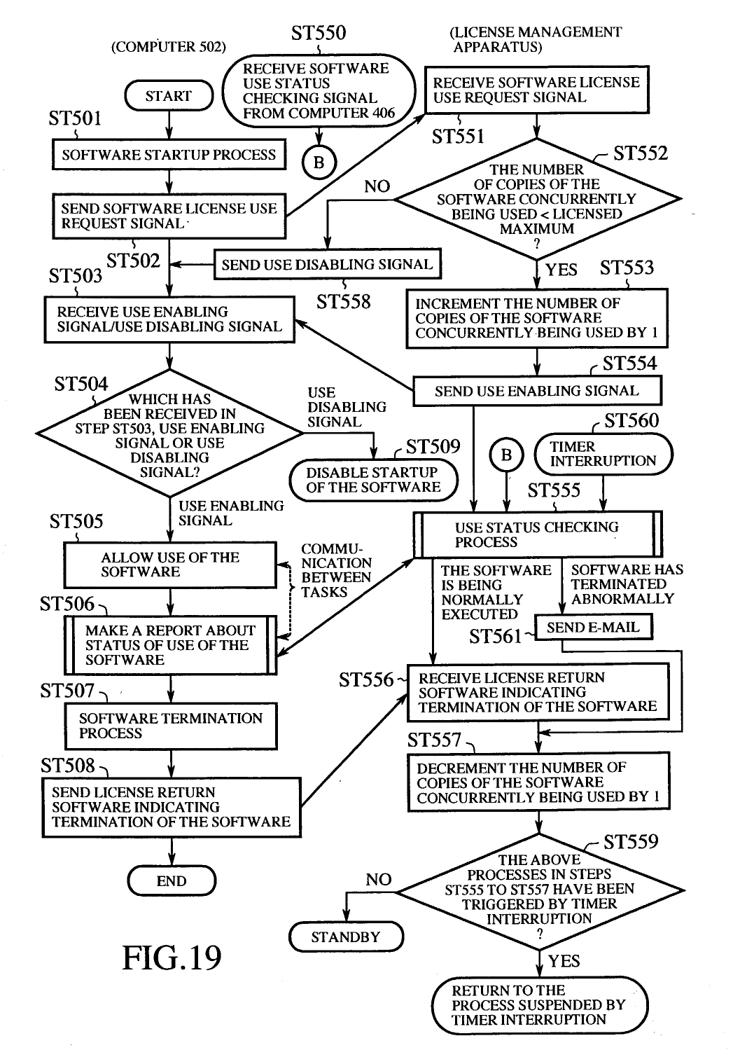

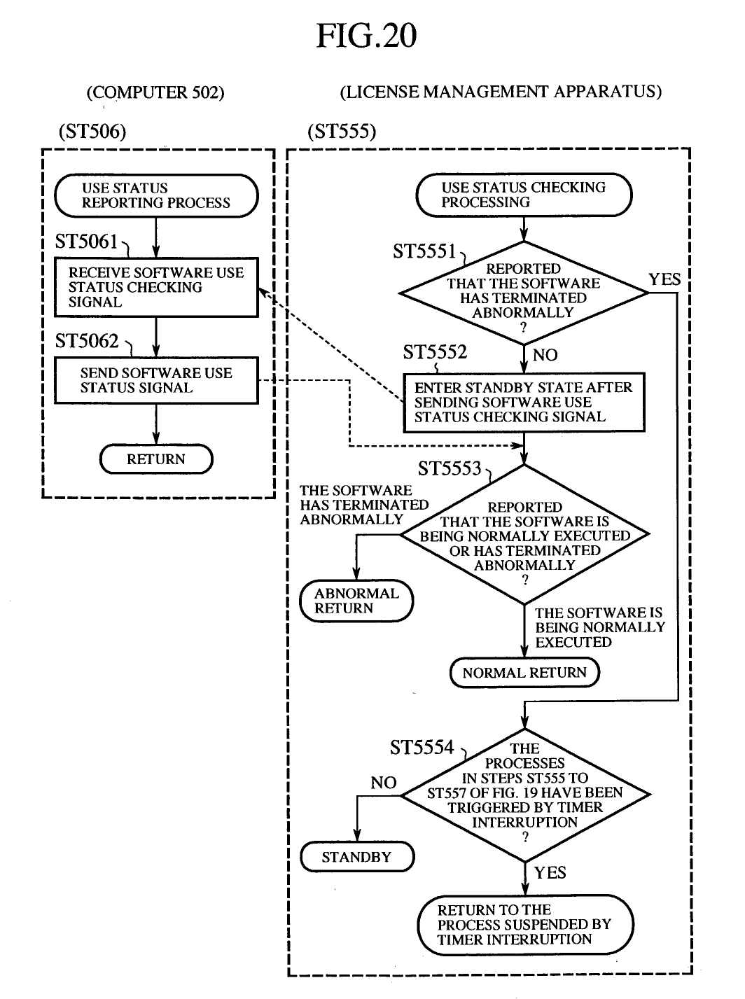

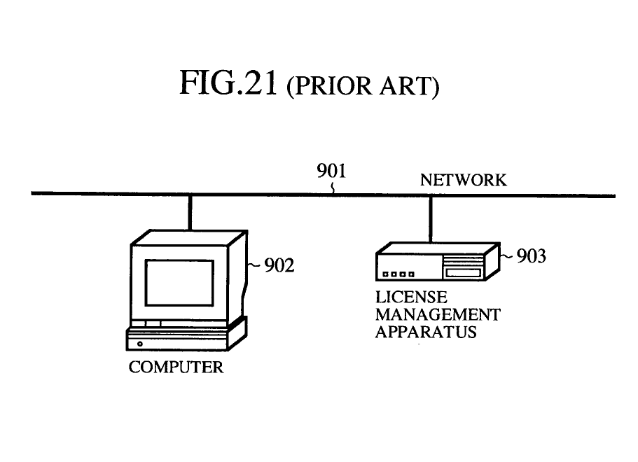

FIG. 19 is a flow chart showing the operation of the software license management system according to the variant of the second embodiment as shown in FIG. 17, and FIG. 20 is a flow chart showing the operations of sub routines of the software license management system according to the variant of the second embodiment as shown in FIG. 17. In FIG. 17 showing the operation of the software license management system, steps ST501 to ST509 of FIG. 19 correspond to steps ST101 to ST109 shown in FIG. 3, respectively, and steps ST551 to ST558 correspond to steps ST151 to ST158 shown in FIG. 3, respectively. Furthermore, step ST550 shown in FIG. 19 corresponds to step ST450 shown in FIG. 15, step ST559 corresponds to step ST359 shown in FIG. 11, step ST560 corresponds to step ST360 shown in FIG. 11, and step ST561 corresponds to step ST259 shown in FIG. 7. In addition, steps ST5061 and ST5062 of FIG. 20 correspond to step ST1061 and ST1062 shown in FIG. 4, respectively, and steps ST5551 to ST5554 correspond to steps ST3551 to ST3554 shown in FIG. 12, respectively.

As mentioned above, in accordance with the second embodiment of the present invention, each computer 402 (or 502) can get permission for the use of a software program to be executed by transmitting a signal (software license use request signal) for making a request to get permission for the use of the software program to a corresponding license management apparatus 403 (or 503). Furthermore, after transmitting a use enabling signal in response to the software license use request signal from each computer 402 (or 502), the corresponding license management apparatus 403 (or 503) checks the execution state of each software program which has been licensed on the computer with the permission to use each software program, and can take the contents of the response (a report indicating whether each licensed software program is being executed or has terminated abnormally) into consideration when determining whether to give permission for the use of a software program in response to a later request to issue permission for the use of the software program. In addition, since each license management apparatus 403 (or 503) can check the status of use of each licensed software program in response to either a software use status checking signal transmitted thereto at an arbitrary time from the corresponding computer 406 ( or 506), which is different from each computer 402 (or 502) which is executing one or more licensed software programs, or an interruption signal periodically transmitted thereto from the corresponding timer 505, each license management apparatus can surely count out the number of copies of each licensed software program that have terminated abnormally and are not used now from the current number of licensed copies of each software program concurrently being used at predetermined intervals and at an arbitrary time. Furthermore, when detecting abnormal termination of a software program on a computer 402 (or 502), a corresponding license management apparatus 403 (or 503) produces and transmits an electronic mail text of notification about the abnormal termination of the software program to the computer 402 (or 502) and mobile terminal equipment (mobile terminal means) or a mobile telephone (mobile terminal means) owned by either a software management person on the computer 402 (or 502) or the user who has selected the software program on the computer 402 (or 502) by way of the corresponding information transmission apparatus 504, so that the software management person on the computer 402 (or 502) or the user who has selected the software program on the computer 402 (or 502) can be informed of the occurrence of abnormality in the software program and can take measures against the abnormality at an earlier time.

A program that makes an apparatus perform the process shown by the flow chart of any one of FIGS. 3, 4, 7, 8, 11, 12, 15, 16, 19, and 20 can be stored in a computer-readable storage medium such as a semiconductor memory, a CD-ROM or a magnetic tape, and therefore can be distributed in the form of the computer-readable storage medium so that a computer, such as a microcomputer, a personal computer, or a general-purpose computer, can read the program from the storage medium and execute the program.

Many widely different embodiments of the present invention may be constructed without departing from the spirit and scope of the present invention. It should be understood that the present invention is not limited to the specific embodiments described in the specification, except as defined in the appended claims.

What is claimed is:

1. A software license management system provided with a plurality of information processing means each of which can use one or more pieces of software and a license management means for managing licenses provided for said one or more pieces of software, said system comprising:
a software usability checking means for issuing a request to get permission for the use of a piece of software, which one of said plurality of information processing means desires to use, from said one information processing means to said license management means;
a software use determination means, responsive to the request made by said one information processing means, for determining whether or not a current number of copies of said piece of software concurrently being used is less than a licensed maximum, and for sending a response giving said one information processing means permission for the use of said piece of software and for incrementing the current number of copies of said piece of software concurrently being used by 1 when determining that the current number of copies of said piece of software concurrently being used is less than the licensed maximum, whereas sending a response not giving said one information processing means permission for the use of said piece of software when determining that the current number of copies of said piece of software concurrently being used is not less than the licensed maximum;
a software use status checking means for inquiring about an execution state of said piece of software of said one information processing means after receiving the response from said software use determination means; and
a user number updating means for, when a response to the inquiry made by said software use status checking means from said one information processing means says that said one information processing means is executing said piece of software, waiting for a notification about completion of said piece of software from said one information processing means, and then decrementing the current number of copies of said piece of software concurrently being used by 1, and for immediately decrementing the current number of copies of said piece of software concurrently being used by 1 when the response to the inquiry from said one information processing means says that said piece of software has terminated abnormally.

2. The software license management system according to claim 1, further comprising a means for, when said software use status checking means makes sure that said piece of software has terminated abnormally, transmitting a notification indicating that said piece of software has terminated abnormally to said one information processing means or mobile terminal equipment owned by a software management person or a user associated with said one information processing means by using an electronic mail transmission means.

3. The software license management system according to claim 1, wherein said system further comprises a timer means for generating an interruption signal at predetermined intervals, and said software use status checking means includes a means for inquiring about the execution state of said piece of software of said one information processing means in response to the interruption signal from said timer means.

4. The software license management system according to claim 1, wherein said plurality of information processing means and said license management means are both connected to the Internet.

5. The software license management system according to claim 2, wherein said electronic mail transmission means is connected to the Internet.
